(19) United States
(12) Patent Application Publication
(10) Pub. No.: US 2014/0186087 A1
(43) Pub. Date: Jul. 3, 2014

(54) PRINTER

(71) Applicant: SEIKO INSTRUMENTS INC., Chiba (JP)

(72) Inventor: Kazuyuki AIZAWA, Chiba (JP)

(73) Assignee: SEIKO INSTRUMENTS INC., Chiba (JP)

(21) Appl. No.: 14/103,906

(22) Filed: Dec. 12, 2013

(30) Foreign Application Priority Data
Dec. 27, 2012 (JP) 2012-285770

(51) Int. Cl. B41J 11/66

(52) U.S. Cl. CPC B41J 11/66
USPC 400/621

(57) ABSTRACT

A printer including: a case including a paper roll receiving portion for receiving a roll; a cover that is openably and closably coupled to the case and locked at the time of a closing operation; a platen unit including a platen roller for feeding recording paper pulled out from the roll; and a head unit that includes a printing head and is separably engaged relatively with respect to the platen unit, in which: one of the platen unit and the head unit is mounted to the cover; the cover includes an operation unit including an operation button and a control board; another of the platen unit and the head unit is mounted to the case; and the case includes a release operation member that is capable of reciprocating between a lock position and a release position and releases a lock of the cover when being moved to the release position.

### BACKGROUND OF THE INVENTION

1. Field of the Invention

The present invention relates to a printer including an openable and closable printer cover.

2. Description of the Related Art

As typified by a thermal printer, in printers that perform printing on recording paper pulled out from a paper roll, there are known many kinds of printers in which a printer cover is coupled in an openable and closable manner to a case for receiving the paper roll in order to facilitate setting of the paper roll.

For example, according to the related art, there are known a printer in which the printer cover is openable and closable in a front-back direction and the recording paper is discharged forward, and a printer in which the printer cover is openable and closable in an up-down direction and the recording paper is discharged upward.

Thermal printers are often installed in stores or the like for use. In order to reduce the installation space and enhance user's usability, the printer is desired to be downsized as much as possible. In general, the case is designed in accordance with the discharge direction of the recording paper, but when, for example, the case is designed so as to support both of forward discharge and upward discharge, the size of the case is increased as compared to a printer in which the discharge direction is limited to one direction. Therefore, downsizing is particularly desired in such a case.

However, when the printer is designed, a printer mechanism including a printing head and a platen roller is arranged inside the case. In addition, a coupling mechanism of the printer cover with respect to the case, a cover opening and closing operation mechanism for locking the printer cover and releasing the lock, and an operation unit for performing operation of the printer are required to be provided even though the space is limited. Therefore, the space around the paper roll received inside the case tends to be filled with the above-mentioned various members. Therefore, for example, it has been difficult to readily take out the paper roll that has been once received, resulting in that the printer has been difficult to handle (that is, the usability has been inhibited).

In particular, in the case of the above-mentioned printer in which the printer cover is openable and closable in the front-back direction and the recording paper is discharged forward, an operation unit including various operation buttons, such as a power button and a sheet feeding button, and a control board for performing various controls in response to depression of those operation buttons are provided on the case side. Therefore, the space around the paper roll inside the case is occupied because the operation unit is mounted, and hence the received paper roll becomes difficult to be taken out.

Further, in the case of the above-mentioned printer in which the printer cover is openable and closable in the up-down direction and the recording paper is discharged upward, although the operation buttons are provided on the printer cover, the control board and the like are still provided on the case side. Therefore, the space around the paper roll inside the case is still occupied because the control board is mounted, and hence the received paper roll becomes difficult to be taken out.

In addition, in any of the above-mentioned related art printers, a release lever for releasing the lock of the printer cover is mounted to the printer cover. In the cover opening and closing operation mechanism, a lock mechanism for locking the printer cover is required to be mounted on the case side. Further, the lock mechanism is required to be linked to the release lever, and hence the lock mechanism is required to be arranged at a position close to the printer cover side.

Therefore, because the above-mentioned lock mechanism is mounted, the space around the paper roll inside the case is further occupied, and hence the received paper roll becomes further difficult to be taken out.

### SUMMARY OF THE INVENTION

In view of the points above, in this technical field, a printer that can be downsized and further secure an open space around a received paper roll so that the paper roll can be easily taken out or replaced has been desired.

(1) According to one embodiment of the present invention, there is provided a printer, including: a case including a paper roll receiving portion for receiving a paper roll; a printer cover that is openably and closably coupled to the case and locked at the time of a closing operation; a platen unit including a platen roller for feeding recording paper pulled out from the paper roll; and a head unit that includes a printing head and is separably engaged relatively with respect to the platen unit, in which: one of the platen unit and the head unit is mounted to the printer cover; the printer cover includes an operation unit including an operation button and a control board; another of the platen unit and the head unit is mounted to the case; and the case includes a release operation member that is capable of reciprocating between a lock position and a release position and releases a lock of the printer cover when being moved to the release position.

According to the printer of the one embodiment of the present invention, the operation unit including the operation button and the control board is provided on the printer cover side, and hence it is unnecessary to secure a space required for mounting the operation unit on the case side. Therefore, the case can be accordingly downsized, and an open space can be secured around the paper roll receiving portion.

In addition, the release operation member for releasing the lock of the printer cover is provided on the case side. Therefore, as compared to the related art in which the release lever is provided on the printer cover side, there is a degree of freedom in its mounting position, and the release lever can be arranged in consideration of the relationship with the paper roll receiving portion. In other words, in a related art printer in which the release lever is provided on the printer cover side, it is necessary to first determine the position of the release lever, and then provide the lock mechanism on the case side so as to correspond to the position of the release lever. Therefore, the design is often subjected to restrictions. However, when the release operation member is provided on the case side, the position of the release operation member can be first determined, and hence, as described above, the printer can be designed while considering the relationship between the release operation member and the paper roll receiving portion. Therefore, also in view of this point, an open space can be easily secured around the paper roll receiving portion.

As described above, the printer can be downsized, and further an open space can be secured around the received paper roll. Further, the paper roll can be easily taken out or replaced with use of the open space.

(2) In the printer according to one embodiment of the present invention, preferably, the one of the platen unit and the head unit includes a lock member to be removably engaged with a portion to be engaged, which is formed on the another of the platen unit and the head unit, at the time of the closing operation of the printer cover, and the another of the platen unit and the head unit includes a unit release mechanism that is configured to actuate in association with the release operation member and cause, when the release operation member is moved to the release position, the lock member to be disengaged from the portion to be engaged so as to release combination between the one of the platen unit and the head unit and the another of the platen unit and the head unit.

In this case, when the printer cover undergoes the closing operation, the platen unit and the head unit are combined with each other and the lock member engages with the portion to be engaged to be locked. With this, the platen unit and the head unit are integrally locked (coupled) to each other. Further, the printer cover is locked by the lock of both the units.

Further, by moving the release operation member provided to the case from the lock position to the release position, the unit release mechanism can be actuated in association therewith, and the lock member can be disengaged from the portion to be engaged. With this, the combination between the platen unit and the head unit can be released to establish a separable state, and an opening operation of the printer cover can be performed.

In particular, the printer cover can be locked with use of the lock at the time of the combination between the platen unit and the head unit, and hence it is unnecessary to provide another lock mechanism for the printer cover. Accordingly, the configuration of the release operation member provided on the case side can be simplified. Therefore, an open space can be further easily secured around the received paper roll, and the paper roll can be further easily taken out or replaced.

(3) In the printer according to one embodiment of the present invention, preferably, the platen unit is provided to the printer cover, the head unit is provided to the case and includes a platen motor for rotating the platen roller, and the platen roller is rotated by receiving a rotational force from the platen motor when the head unit and the platen unit are combined with each other.

In this case, the platen motor is provided to the head unit, and hence it is unnecessary to provide another mechanism for rotating the platen roller on the case side separately from that in the head unit. Therefore, accordingly, a further wide-range open space can be easily secured around the paper roll receiving portion.

(4) In the printer according to one embodiment of the present invention, preferably, the printer further includes a cutter mechanism for cutting the recording paper, the cutter mechanism including a fixed blade and a movable blade, and one of the fixed blade and the movable blade is provided to the head unit, while another of the fixed blade and the movable blade is provided to the platen unit.

In this case, the printed recording paper can be cut with use of the cutter mechanism, and hence a value can be added as the printer. Further, it is unnecessary to provide another cutter mechanism to the printer cover and the case separately from that in the head unit and the platen unit, and hence a further wide-range open space can be easily secured around the paper roll receiving portion.

### BRIEF DESCRIPTION OF THE DRAWINGS

FIG. 1 is a view illustrating an embodiment of the present invention, and is a perspective view illustrating an external appearance of a thermal printer.

FIG. 2 is a perspective view illustrating a state in which a printer cover is opened from the state illustrated in FIG. 1.

FIG. 3 is a perspective view illustrating the thermal printer in the state illustrated in FIG. 2 as viewed from a different angle.

FIG. 4 is a vertical sectional view of the thermal printer in the state illustrated in FIG. 2.

FIG. 5 is a sectional view taken along the line A-A in the thermal printer in the state illustrated in FIG. 3.

FIG. 6 is a perspective view of a platen unit forming the thermal printer.

FIG. 7 is a view illustrating a state in which a mounting plate is removed from the state illustrated in FIG. 6.

FIG. 8 is a perspective view of a head unit forming the thermal printer.

FIG. 9 is a view illustrating a state in which a cover plate is removed from the state illustrated in FIG. 8.

FIG. 10 is a view illustrating a state in which a movable blade is slid to cut recording paper between a fixed blade and the movable blade.

FIG. 11 is a side view of the head unit illustrated in FIG. 9 as viewed from an arrow B direction.

FIG. 12 is a side view of the head unit illustrated in FIG. 9 as viewed from an arrow D direction.

FIG. 13 is a view illustrating a state in which a lever portion undergoes a push-down operation from the state illustrated in FIG. 11.

FIG. 14 is a sectional view taken along the line E-E in the thermal printer in the state illustrated in FIG. 3.

FIG. 15 is a sectional view taken along the line F-F in the thermal printer in the state illustrated in FIG. 3.

FIG. 16 is a perspective view illustrating a state in which the attitude of the thermal printer illustrated in FIG. 1 is changed so that a discharge direction of the recording paper is set forward.

FIG. 17 is a perspective view illustrating a state in which the printer cover is opened from the state illustrated in FIG. 16.

### DETAILED DESCRIPTION OF THE PREFERRED EMBODIMENT

Now, an embodiment of the present invention is described with reference to the drawings. Note that, in this embodiment, a thermal printer to be used in a POS register system or the like is described as an example.

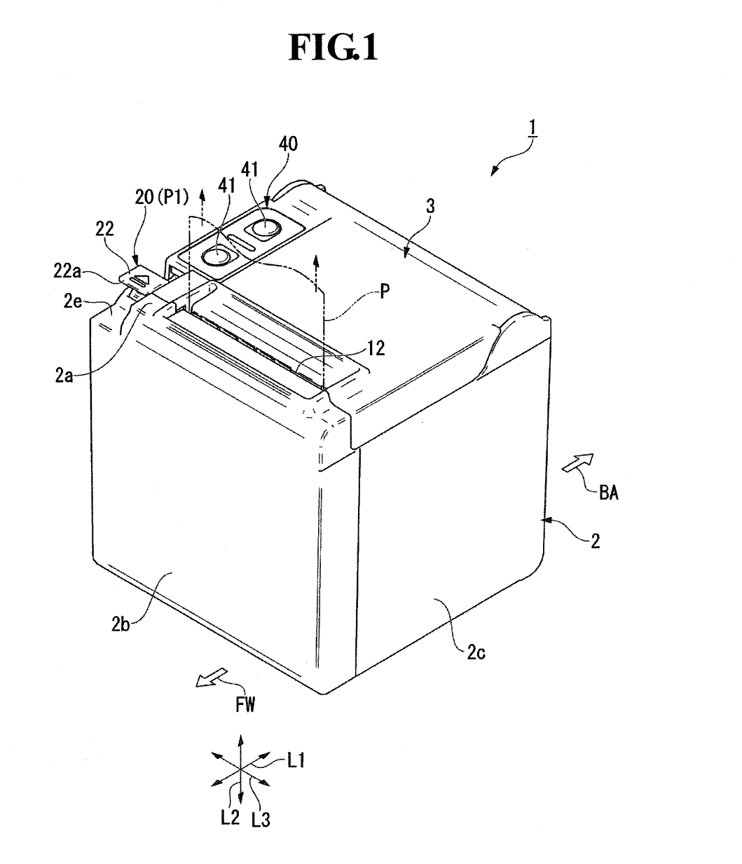

As illustrated in FIGS. 1 to 3, a thermal printer 1 of this embodiment is a printer that performs printing on recording paper P (heat sensitive paper) pulled out from a paper roll R so that the recording paper P may be used as a ticket, a receipt, or the like. The thermal printer 1 includes a casing (case) 2, a printer cover 3, a platen unit 4, and a head unit 5.

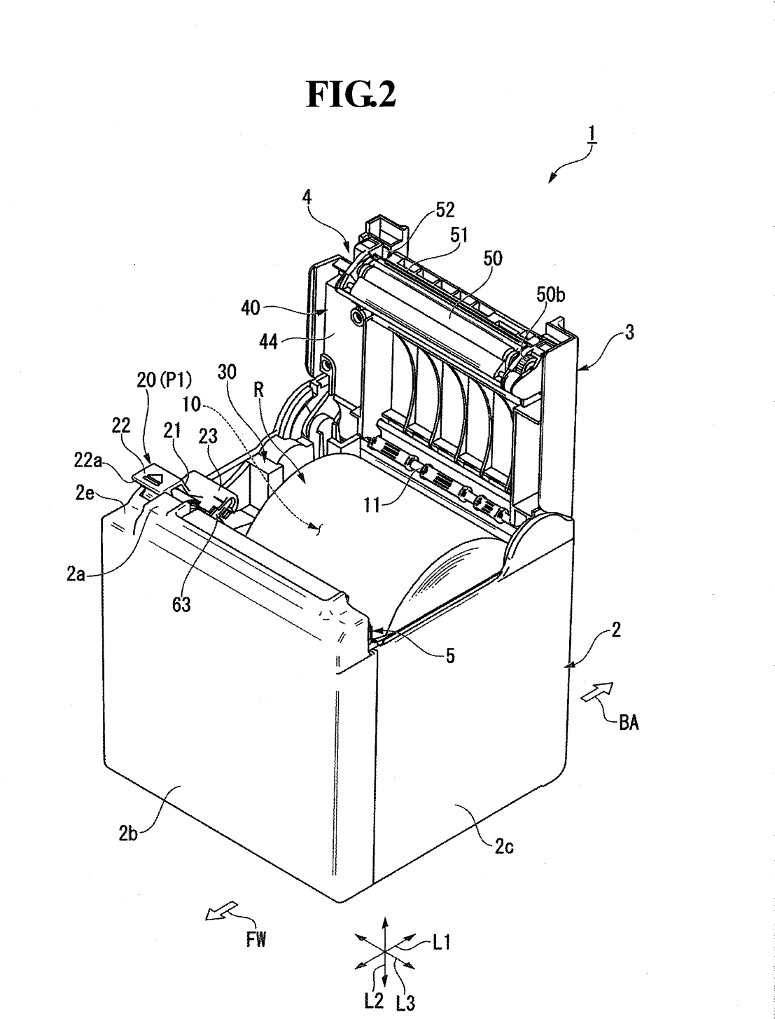

Note that, in this embodiment, in the state illustrated in FIGS. 1 and 2, the lower left side, the upper right side, the upper side, and the lower side of the drawing sheet are referred to as forward (arrow FW direction), backward (arrow BA direction), upward, and downward, respectively, and the recording paper P is fed upward. Further, a direction orthogonal to a front-back direction L1 and an up-down direction L2 is referred to as left-right direction L3. Therefore, each direction may be reversed depending on each figure.

The casing 2 is formed into a cube shape having a top opening, which is made of a plastic material, a metal material, or an appropriate combination of those materials. The casing 2 includes a frame body serving as a basic structure and an exterior cover for covering the frame body.

Inside the casing 2, a paper roll receiving portion 10 in which the paper roll R is to be received is formed. The paper roll receiving portion 10 is opened by opening the printer cover 3. Further, the printer cover 3 is coupled to an upper surface 2a of the casing 2 via a rotational shaft portion 11, and is coupled so as to be openable and closable in a range of an angle of substantially 90° about the rotational shaft portion 11. As described above, the paper roll receiving portion 10 is opened when the printer cover 3 undergoes an opening operation, and for example, the paper roll R can be put inside. In other words, the paper roll R is received in a so-called drop-in system.

Further, the printer 1 is designed so that, when the printer cover 3 undergoes a closing operation, a slight gap is provided between the leading end of the printer cover 3 and the casing 2 (see FIG. 1). The recording paper P is discharged by being upwardly pulled out from the inside of the casing 2 with use of this gap. Therefore, this gap functions as a discharge port 12 for the recording paper P. Note that, the printer cover 3 is locked when the closing operation is performed. Specifically, the lock is achieved when the platen unit 4 and the head unit 5 are combined to be integrally coupled to each other.

Further, the casing 2 of this embodiment includes, at a corner portion at which the upper surface 2a, a front surface 2b, and one side surface 2c intersect with each other, a release lever (release operation member) 20 for releasing the lock of the printer cover 3 to perform the opening operation of the printer cover 3. This release lever 20 is described in detail later.

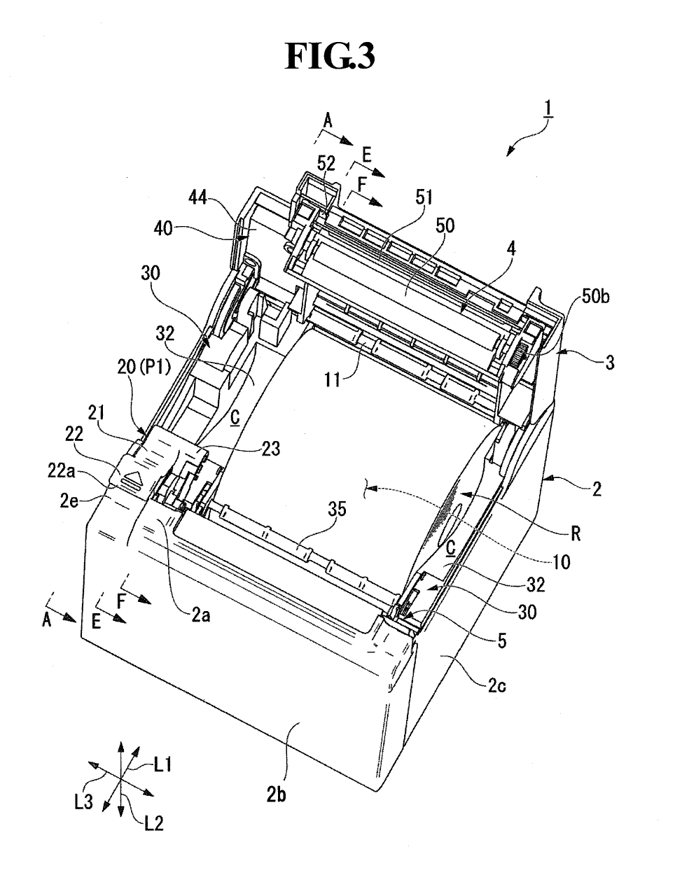

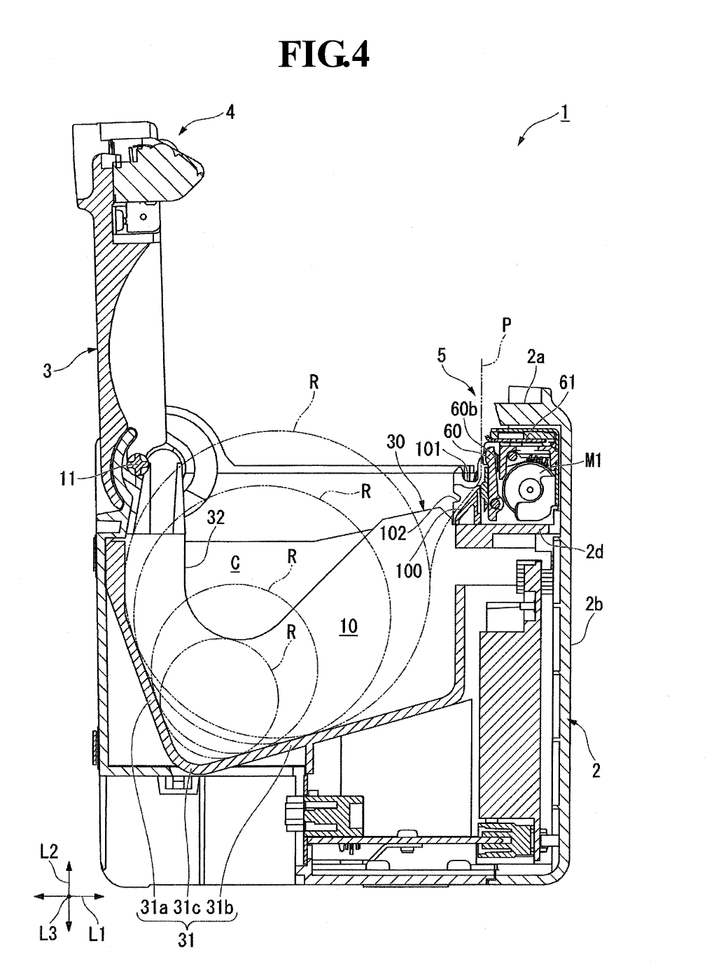

The above-mentioned paper roll receiving portion 10 includes, as illustrated in FIGS. 3 and 4, a pair of side wall portions 30 and a support wall portion 31 that is brought into contact with the outer circumferential surface of the paper roll R to support the paper roll R from the lower side. Note that, the pair of side wall portions 30 and the support wall portion 31 are parts of the frame body forming the casing 2. The pair of side wall portions 30 are arranged so as to be opposed to each other in the left-right direction L3 so as to sandwich the paper roll R to be received. The separation distance of the pair of side wall portions 30 is slightly larger than the lateral width of the paper roll R. With this, both end surfaces of the received paper roll R are supported by inner wall surfaces of the pair of side wall portions 30, to thereby restrict its position in the left-right direction L3.

As illustrated in FIG. 4, the support wall portion 31 is formed into a V-shape in vertical sectional view, and includes a first support surface 31a located on the upstream side in a rotational direction of the paper roll R, a second support surface 31b located on the downstream side in the rotational direction of the paper roll R, and a bottom portion 31c that is located between the first support surface 31a and the second support surface 31b and is provided continuous to the first support surface 31a and the second support surface 31b. With this, the paper roll R is stably supported by being moved downward toward the bottom portion 31c as the diameter of the paper roll R decreases along with use. As described above, the paper roll R received in the paper roll receiving portion 10 is stably and rotatably supported by the pair of side wall portions 30 and the support wall portion 31 without a backlash in the left-right direction L3 regardless of the diameter of the paper roll R.

By the way, each of the pair of side wall portions 30 of this embodiment includes, as illustrated in FIGS. 3 and 4, a cutout portion 32 opened on the inner side and the upper side of the casing 2. In the illustrated example, the cutout portion 32 is formed into an arc shape in side view, in which the length in the front-back direction L1 is gradually reduced from the upper side toward the lower side. Therefore, when the paper roll R is received inside the paper roll receiving portion 10, both the end surfaces of the paper roll R can be exposed through spaces defined by the cutout portions 32 (see FIG. 3). Thus, with use of the spaces, for example, the paper roll R can be taken out from the paper roll receiving portion 10 by holding both the end surfaces of the paper roll R without touching the outer circumferential surface of the paper roll R. Note that, the above-mentioned spaces defined by the cutout portions 32 function as paper roll access spaces C.

Further, between the pair of side wall portions 30, a tension roller 35 (see FIG. 3) is provided so as to extend across in the left-right direction L3. The tension roller 35 biases the recording paper P pulled out from the paper roll R by a biasing member (not shown) such as a spring to apply a tension to the recording paper P. With this, the recording paper P is pulled out from the paper roll R in a state in which the recording paper P is less likely to be loosened, and is supplied between the platen unit 4 and the head unit 5.

Further, as illustrated in FIGS. 1, 2, and 5, the printer cover 3 of this embodiment includes an operation unit 40 including operation buttons 41 and a control board 42. The operation buttons 41 are, for example, a power button and a sheet feeding button, and are arranged in a state of being exposed on the outer surface of the printer cover 3 so that the operation buttons 41 can be depressed. In the illustrated example, the operation buttons 41 are arranged so as to be arrayed in one row in the front-back direction L1 with respect to the release lever 20.

The control board 42 is a board in which a plurality of electronic parts (not shown) and switches 43 (such as membrane switches) that are turned on through depression of the operation buttons 41 are mounted, and which comprehensively controls the actuation of the thermal printer 1. The control board 42 is arranged so as to be located on the inner surface side of the printer cover 3 and on the rear side of the operation buttons 41. Note that, the control board 42 is covered with a protective cover 44 mounted on the inner surface side of the printer cover 3.

As illustrated in FIGS. 3 and 4, the above-mentioned platen unit 4 is a unit mainly incorporating a platen roller 50 and a fixed blade 51, and is provided to the printer cover 3. Specifically, the platen unit 4 is mounted on the inner surface on the leading end side of the printer cover 3 through intermediation of a mounting plate 52. Therefore, the platen unit 4 moves along with an opening and closing operation of the printer cover 3, and can be combined relatively with respect to the head unit 5.

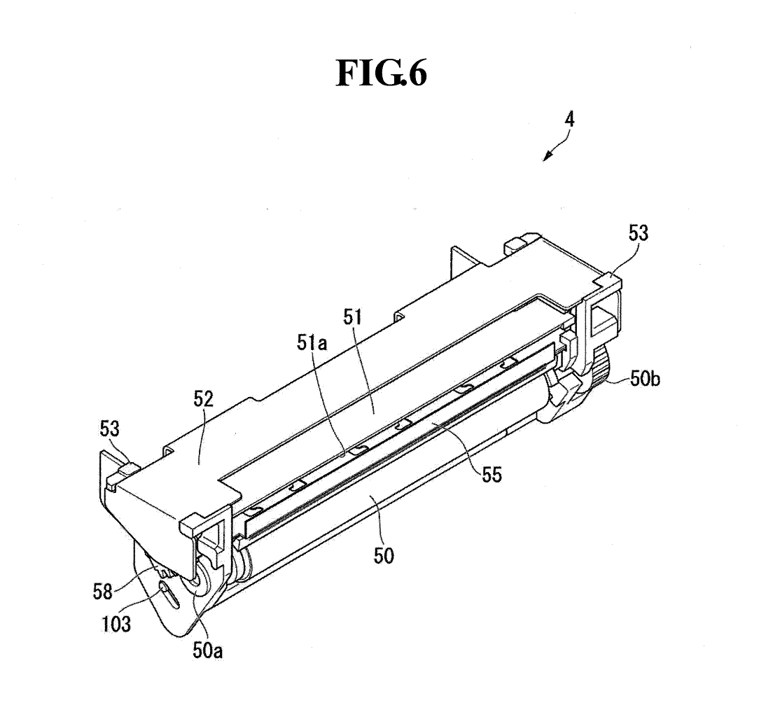

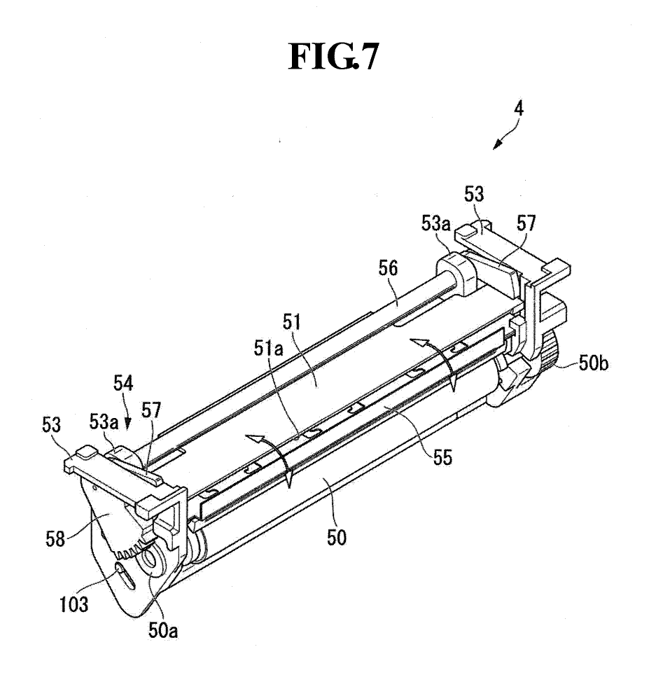

Now, the configuration of the platen unit 4 is described in detail. As illustrated in FIGS. 6 and 7, the platen unit 4 includes the platen roller 50 for feeding the recording paper P, the fixed blade 51 arranged on the downstream side in a transporting direction of the recording paper P with respect to the platen roller 50, a metallic platen frame 53 for rotatably supporting the platen roller 50, and the metallic mounting plate 52 for covering the upper side of the platen frame 53. Further, the platen unit 4 of the this embodiment includes an interlocking mechanism 54 including pressing portions for releasing a contact pressure between the fixed blade 51 and a movable blade 61 to be described later as necessary.

The platen roller 50 is supported by the platen frame 53 through intermediation of bearings 50a mounted on both ends of a shaft body (not shown). In this case, on one end side of the platen roller 50, a driven gear 50b is fixed under a state in which the driven gear 50b is coupled to the shaft body across the bearing 50a.

The platen roller 50 is arranged so that, when the printer cover 3 is closed and the platen unit 4 and the head unit 5 are combined with each other, the outer circumferential surface of the platen roller 50 is brought into contact with a thermal head 60 to be described later on the head unit 5 side under a state in which the recording paper P is sandwiched therebetween. Further, at this time, the driven gear 50b meshes with a platen gear train 90 to be described later on the head unit 5 side so that a rotational force is transmitted to the driven gear 50b. With this, after the printer cover 3 is closed, the platen roller 50 is rotated by the rotational force transmitted from the head unit 5 side, and thus the recording paper P can be fed outside the casing 2 from the discharge port 12.

The fixed blade 51 is a plate-like blade extending in the width direction of the recording paper P, and is supported by a fixed blade holder 55 so that, when the printer cover 3 is closed, a blade edge 51a is opposed to the fed recording paper P. At this time, the fixed blade 51 is supported in a manner that the blade edge 51a side is swingable in the up-down direction (direction substantially orthogonal to a sliding direction of the movable blade 61). Note that, the fixed blade 51 is biased by a biasing member (not shown) provided between the fixed blade holder 55 and the fixed blade 51 so that the blade edge 51a side is constantly raised.

Between the fixed blade 51 and the mounting plate 52, a rotatable shaft 56 is arranged along the fixed blade 51 on the root side of the fixed blade 51. This shaft 56 is rotatably supported by bearing members 53a fixed to the platen frame 53. Further, onto one end side of the shaft 56, a pressing portion 57 and a sector gear 58 are coupled, and onto the other end side thereof, merely a pressing portion 57 is coupled.

When the printer cover 3 is closed, the sector gear 58 meshes with an internal gear 63a of a lever portion 63 to be described later provided on the head unit 5 side. Therefore, the sector gear 58 and the shaft 56 are rotated in association with a push-down operation of the lever portion 63. The pressing portions 57 are coupled to the shaft 56 so as to be located on the inner side of the platen frame 53 and at both ends of the fixed blade 51. Further, the pressing portions 57 rotate together with the shaft 56 along with the rotation of the sector gear 58, and press downward the blade edge 51a side of the fixed blade 51. With this, the fixed blade 51 moves so as to separate from the movable blade 61. Thus, the fixed blade 51 functions to release the contact pressure between the two blades 51 and 61. That is, those two pressing portions 57, the sector gear 58, and the shaft 56 function as the interlocking mechanism 54 for moving the fixed blade 51 in a direction in which the fixed blade 51 is separated from the movable blade 61 in association with the operation of the lever portion 63, to thereby release the contact pressure between the two blades 51 and 61.

As illustrated in FIGS. 3 and 4, the above-mentioned head unit 5 is a unit mainly incorporating the thermal head (printing head) 60 and the movable blade 61, and is provided to the casing 2. Specifically, the head unit 5 is fixed onto an internal plate 2d provided above the second support surface 31b in the paper roll receiving portion 10 and continuously provided on the inner side of the front surface 2b of the casing 2.

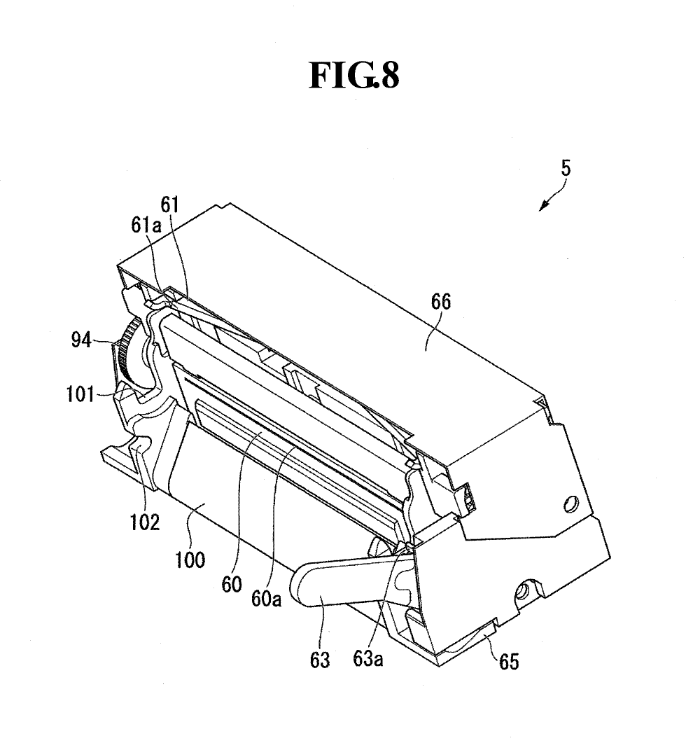

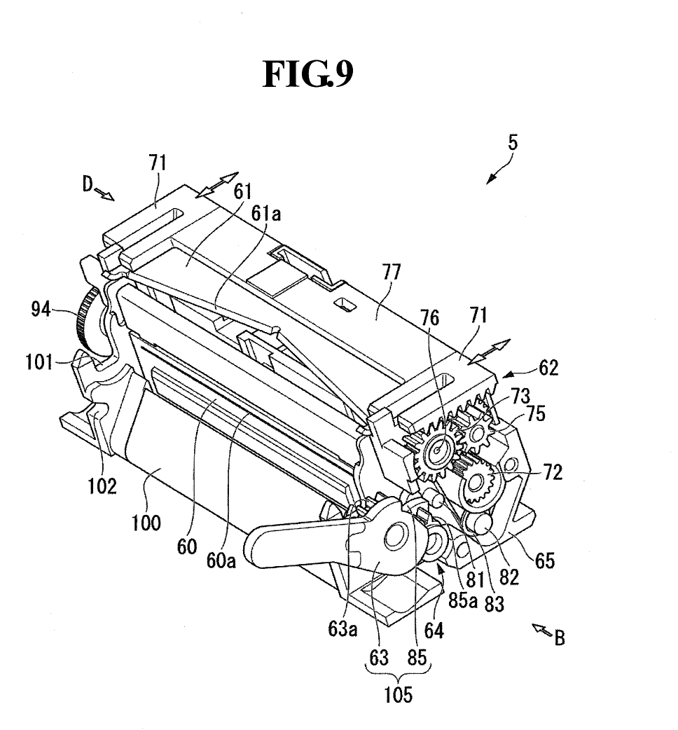

Now, the configuration of the head unit 5 is described in detail. As illustrated in FIGS. 8 and 9, the head unit 5 includes the movable blade 61 that moves in a sliding manner with respect to the fixed blade 51, a movable blade drive system 62 for driving the movable blade 61, the lever portion 63 capable of undergoing the push-down operation, a release mechanism 64 for disengaging the mechanical connection between a drive gear 72 and a rack 71 to be described later in association with the push-down motion of the lever portion 63, the thermal head 60 for performing recording on the pulled-out recording paper P, a metallic support frame 65 for supporting those components, the support frame 65 being fixed on the internal plate 2d, and a metallic cover plate 66 for covering the upper side of the movable blade 61.

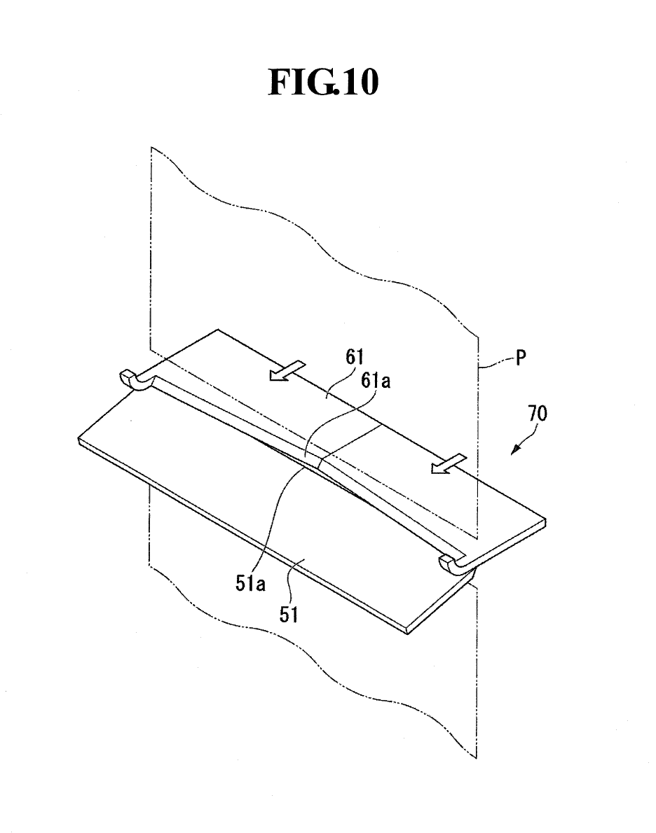

The movable blade 61 is arranged at a position opposed to the fixed blade 51 when the printer cover 3 is closed and the head unit 5 and the platen unit 4 are combined with each other. As illustrated in FIG. 10, the movable blade 61 is a plate-like blade formed into a substantially V-shape in top view so that the length from the root to a blade edge 61a is gradually reduced from both ends toward the center. The movable blade 61 rides on the upper surface of the fixed blade 51 when the movable blade 61 is slid toward the fixed blade 51. In this state, the recording paper P can be sandwiched between the movable blade 61 and the fixed blade 51 to be cut. Note that, the fixed blade 51 and the movable blade 61 function as a cutter mechanism 70. Further, the fixed blade 51 is biased upward, and hence when the movable blade 61 is slid, both of the blades 51 and 61 are brought into contact with each other with an appropriate contact pressure.

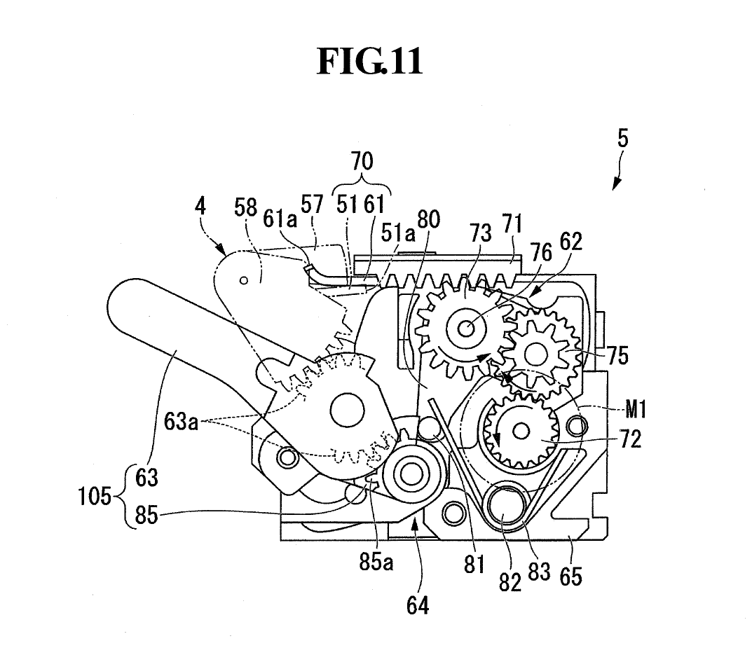

As illustrated in FIGS. 9 and 11, the movable blade drive system 62 includes the racks 71 mounted to the movable blade 61, and a first gear 73 and a third gear 74 (not shown in FIGS. 9 and 11) that mesh with the respective racks 71 and rotate along with the rotation of the drive gear 72 coupled to a cutter motor M1 that can rotate in forward and reverse directions so as to linearly move the racks 71 in the direction of the arrows illustrated in FIG. 9.

The drive gear 72 is coupled to a drive shaft of the cutter motor M1, and is arranged on one side surface side of the head unit 5. Above the drive gear 72, the above-mentioned first gear 73 is arranged in a state of meshing with the rack 71. Between the first gear 73 and the drive gear 72, a second gear 75 meshing with both the gears 72 and 73 is arranged. Thus, when the drive gear 72 is rotated by the drive of the cutter motor M1, the rotational force is transmitted to the first gear 73 via the second gear 75, and thus the rack 71 linearly moves. In other words, the first gear 73 rotates along with the rotation of the drive gear 72 to linearly move the rack 71.

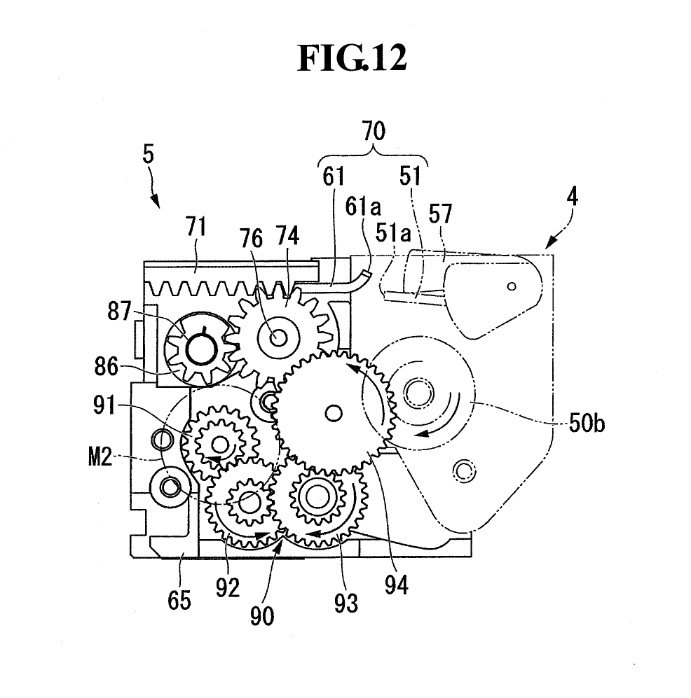

Further, the first gear 73 is coupled to a shaft 76 extending to reach the other side surface side of the head unit 5. As illustrated in FIG. 12, on the other side surface side of the head unit 5, the above-mentioned third gear 74 meshing with the rack 71 is coupled to the shaft 76. Therefore, the third gear 74 also rotates along with the rotation of the first gear 73, to thereby linearly move the rack 71 similarly.

As illustrated in FIG. 9, the racks 71 are mounted to both ends of a support plate 77 fixed to the root side of the movable blade 61. Therefore, when the first gear 73 and the third gear 74 are rotated, the two racks 71 simultaneously move in the same direction, and as a result, the movable blade 61 is moved in a sliding manner.

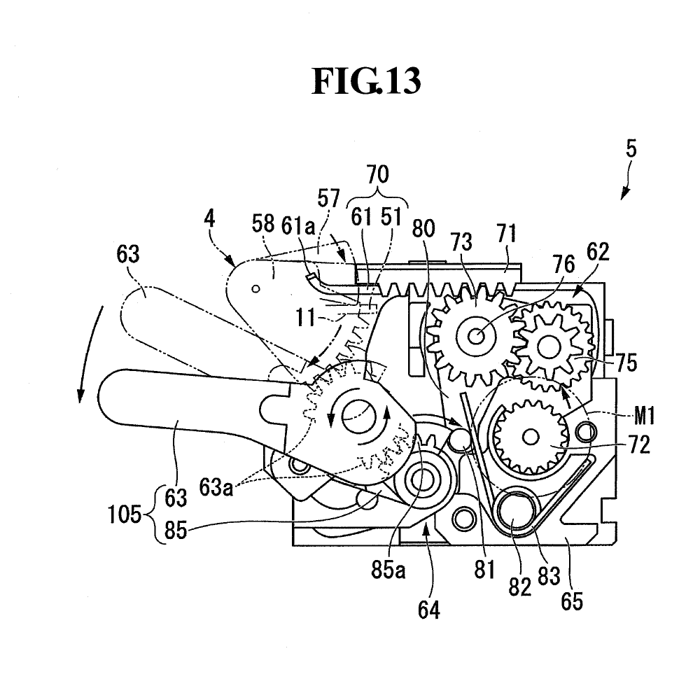

As illustrated in FIG. 11, a swing plate 80 formed into a substantially C-shape in plan view is arranged on the inner side of the first gear 73. This swing plate 80 can swing on left and right sides about the shaft 76 coupled to the first gear 73. Further, the second gear 75 is rotationally supported by the swing plate 80. Therefore, when the swing plate 80 swings, as illustrated in FIG. 13, the second gear 75 swings about the shaft 76.

Further, as illustrated in FIGS. 9 and 11, a pin 81 that protrudes outward of the head unit 5 is mounted to the end portion of the swing plate 80. Further, the design is made as follows. As illustrated in FIG. 13, when the swing plate 80 is moved so that the pin 81 approaches the drive gear 72, the second gear 75 moves in a direction in which the second gear 75 separates from the drive gear 72. As illustrated in FIG. 11, when the swing plate 80 is moved so that the pin 81 separates from the drive gear 72, the second gear 75 moves in a direction in which the second gear 75 approaches the drive gear 72.

In this case, as illustrated in FIGS. 9 and 11, a fixed pin 82 is formed below the drive gear 72. A torsion spring 83 is fixed to this fixed pin 82. One end side of the torsion spring 83 is fixed to the support frame 65, and the other end side thereof constantly biases the above-mentioned pin 81 in a direction in which the pin 81 separates from the drive gear 72. Therefore, as described above, in the normal state, the second gear 75 and the drive gear 72 are constantly in a meshing state.

Further, the above-mentioned lever portion 63 is arranged adjacent to the swing plate 80. The lever portion 63 is rotationally supported, and can be operated to be pushed downward. The internal gear 63a is formed on the inner side of the lever portion 63. When the printer cover 3 is closed and the head unit 5 and the platen unit 4 are combined with each other, a part of the internal gear 63a meshes with the sector gear 58 on the platen unit 4 side. In this manner, as described above, the interlocking mechanism 54 can be actuated in association with the push-down motion of the lever portion 63.

Further, between the lever portion 63 and the swing plate 80, a release plate 85 formed into a sector is arranged, which is rotationally supported by the support frame 65. A release gear 85a is mounted to the release plate 85, and the release gear 85a meshes with a part of the internal gear 63a of the lever portion 63. Therefore, as illustrated in FIG. 13, when the lever portion 63 is pushed downward, the release plate 85 rotates toward the drive gear 72 side.

The side surface of the release plate 85 abuts against the pin 81 of the swing plate 80 which is biased by the torsion spring 83. Therefore, when the release plate 85 is rotated toward the drive gear 72 side, the pin 81 is pushed toward the drive gear 72 side against the biasing force of the torsion spring 83, and thus the swing plate 80 can be moved. As a result, the second gear 75 can be separated from the drive gear 72 to release the meshing state therebetween, and the second gear 75, the first gear 73, and the rack 71 can be set to a free state.

In other words, it is possible to disengage the mechanical connection between the rack 71 and the drive gear 72, and remove the movement restriction of the rack 71 to obtain a free state. That is, the swing plate 80, the pin 81, the torsion spring 83, and the release plate 85 described above function as the above-mentioned release mechanism 64.

Further, as illustrated in FIG. 12, on the other side surface of the head unit 5, a pinion 86 meshing with the third gear 74 is rotationally supported by the support frame 65. The pinion 86 incorporates a coil spring 87. The coil spring 87 is compressed when the third gear 74 rotates to move the movable blade 61 in a sliding manner toward the fixed blade 51, and rotationally biases the pinion 86 so as to cause the third gear 74 to reversely rotate. Note that, in the normal state, the third gear 74 engages with the drive gear 72, and hence the third gear 74 cannot be reversely rotated by the force of the coil spring 87.

However, when the movement restriction of the rack 71 is removed by the release mechanism 64 so that the rack 71 is set to a free state, the third gear 74 is reversely rotated by the force of the coil spring 87. As a result, the movable blade 61 can be automatically returned to the original position. In other words, when the movement restriction of the rack 71 is removed, the coil spring 87 functions as a biasing member for automatically bringing the movable blade 61 back to the original position.

Further, below the pinion 86, the platen gear train 90 meshing with the driven gear 50b on the platen unit 4 side when the head unit 5 and the platen unit 4 are combined with each other, and a platen drive gear 91 that is coupled to a drive shaft of a platen motor M2 and meshes with the platen gear train 90 are provided. The platen gear train 90 includes a fourth gear 92 meshing with the platen drive gear 91, a fifth gear 93 meshing with the fourth gear 92, and a sixth gear 94 meshing with the fifth gear 93 and the driven gear 50b. With this, when the head unit 5 and the platen unit 4 are combined with each other, the rotational force of the platen motor M2 can be transmitted to the platen roller 50 to rotate the platen roller 50.

As illustrated in FIGS. 4 and 8, the thermal head 60 is formed so as to extend in the width direction of the recording paper P, and is arranged at a position opposed to the platen roller 50 when the printer cover 3 is closed. Further, the thermal head 60 includes a plurality of heat generating elements 60a arrayed in a line along the width direction of the recording paper P, and is biased toward the platen roller 50 side by a coil spring 60b (see FIG. 4). With this, the thermal head 60 can be reliably pressed against the recording paper P fed by the platen roller 50, and thus satisfactory printing can be performed.

As illustrated in FIG. 8, a guide seat 100 that is curved so as to smoothly pull in the recording paper P is formed below the thermal head 60. A fitting hole 101 in which the bearing 50a of the platen roller 50 is fitted is formed above the guide seat 100. In other words, when the printer cover 3 is closed, the bearing 50a of the platen roller 50 is fitted into the fitting hole 101, and thus the head unit 5 and the platen unit 4 are combined with each other.

By the way, a lock shaft (lock member) 103 is mounted to the platen unit 4. The lock shaft 103 is engaged by being removably fitted into a lock groove (portion to be engaged) 102 formed below the above-mentioned fitting hole 101 as illustrated in FIG. 8. The lock shaft 103 is a shaft arranged in parallel to the platen roller 50 at a part located below the platen roller 50, and is locked by being engaged with the lock groove 102 when both the units 4 and 5 are combined with each other. With this, unless this lock is released, both the units 4 and 5 cannot be separated from each other.

The above-mentioned lock can be released with use of the lever portion 63 and the release plate 85 described above. As described above, as illustrated in FIG. 13, the release plate 85 rotates toward the drive gear 72 side along with the push-down motion of the lever portion 63 to push the pin 81 toward the drive gear 72 side against the biasing force of the torsion spring 83, thereby functioning to move the swing plate 80. In addition, the release plate 85 functions to disengage the lock shaft 103 from the lock groove 102 by a claw portion (not shown) along with a further push-down motion of the lever portion 63. In other words, the lever portion 63 and the release plate 85 of this embodiment function as a unit release mechanism 105 for disengaging the lock shaft 103 from the lock groove 102 to release the combination between the head unit 5 and the platen roller 50.

Next, the release lever 20 provided to the casing 2 is described in detail. As illustrated in FIGS. 2, 3, and 5, the release lever 20 is a lever that is capable of being pivotably operated (capable of reciprocating) between a lock position P1 and a release position P2, and that releases the lock of the printer cover 3 when being moved to the release position P2. The release lever 20 includes a lever main body 21, an operation protrusion 22, and a connector 23.

The lever main body 21 is arranged further below a recessed surface 2e that is one step lower than the upper surface 2a of the casing 2, and is pivotably coupled to a coupling shaft portion 24 provided to the frame body and extending in the left-right direction L3. With this, the release lever 20 is pivotable in the up-down direction about the coupling shaft portion 24.

The operation protrusion 22 is formed so as to protrude upward from the lever main body 21, and protrudes upward with respect to the above-mentioned recessed surface 2e. Further, the operation protrusion 22 includes an operation protruding piece 22a at an upper end portion thereof, which is formed as a flat end so as to be substantially flush with the upper surface 2a of the casing 2 and protrudes from the back side toward the front side of the casing 2. With this, for example, a fingertip may be hooked to the operation protruding piece 22a so as to pivotably operate the release lever 20 from the front side toward the back side.

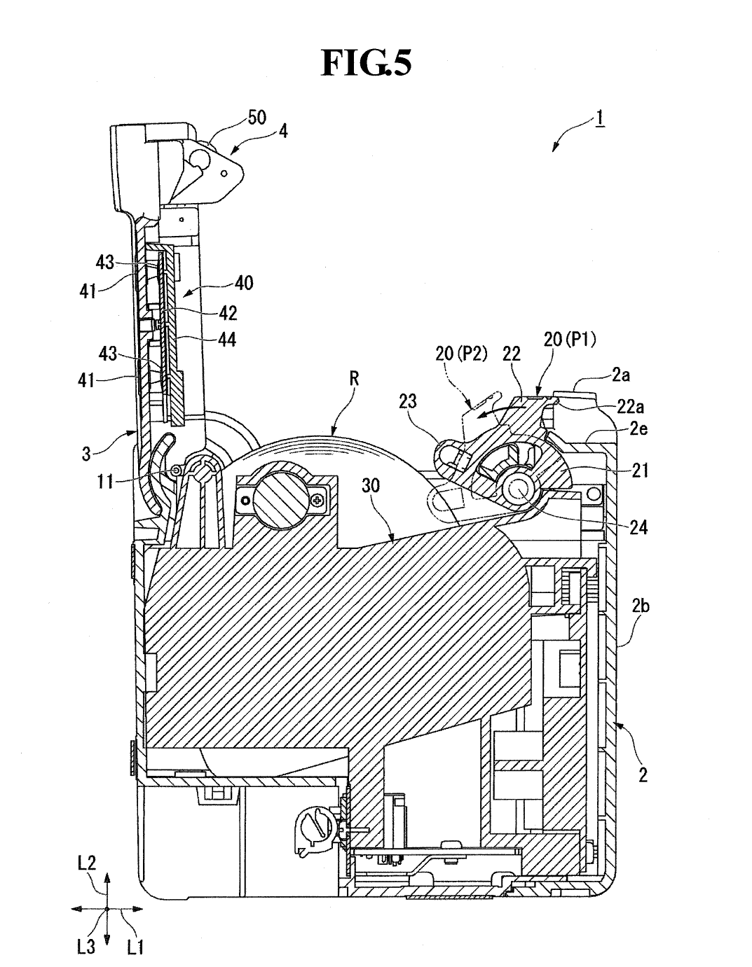

Note that, the lever main body 21 receives a biasing force by a biasing member (not shown) such as a spring so as to cause the operation protrusion 22 to move forward. At this time, as illustrated in FIG. 5, the operation protrusion 22 is brought into contact with an opening edge of the recessed surface 2e in the casing 2 at an upwardly erected position, and is positioned here. With this, in the normal state, the attitude of the release lever 20 is retained under a state in which the operation protrusion 22 is upwardly erected. Note that, this position is set as the above-mentioned lock position P1.

On the other hand, when the release lever 20 is pivoted so that the operation protrusion 22 is moved backward (direction of an arrow illustrated in FIG. 5) from the lock position P1, the lever main body 21 abuts against the upper end surface of one of the side wall portions 30 to be positioned so that further pivoting is restricted. With this, the attitude of the release lever 20 is retained under a state in which the operation protrusion 22 is tilted backward. This position is set as the above-mentioned release position P2. As described above, the release lever 20 can be pivotably operated between the lock position P1 and the release position P2.

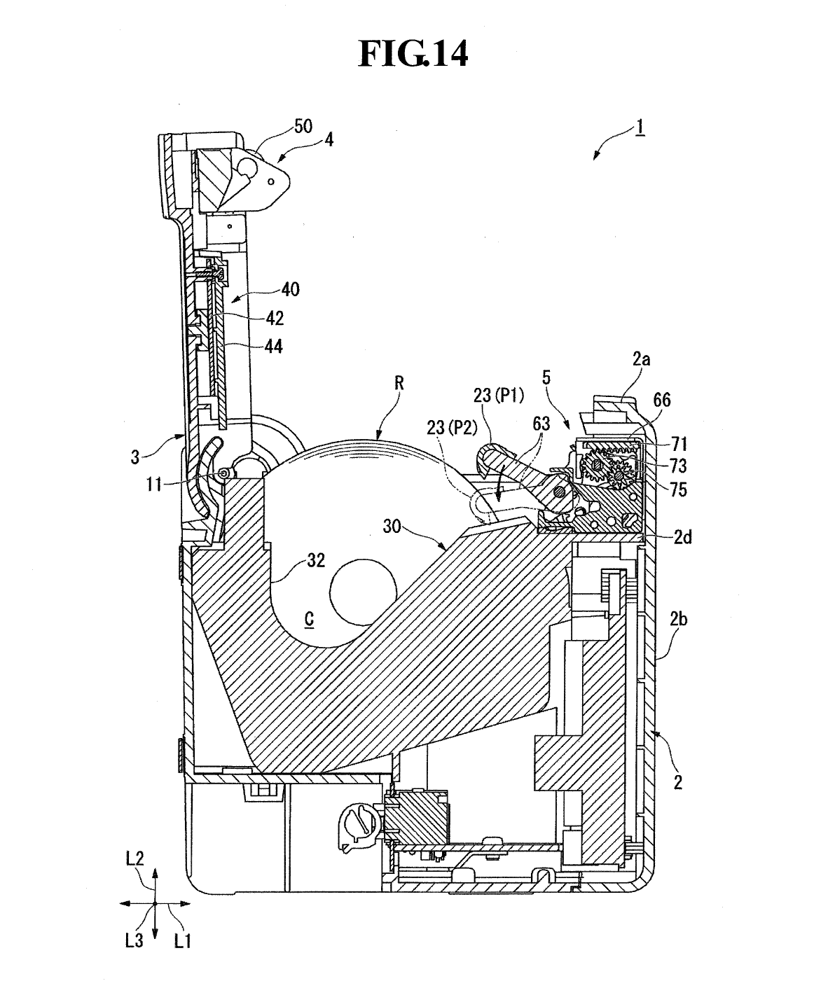

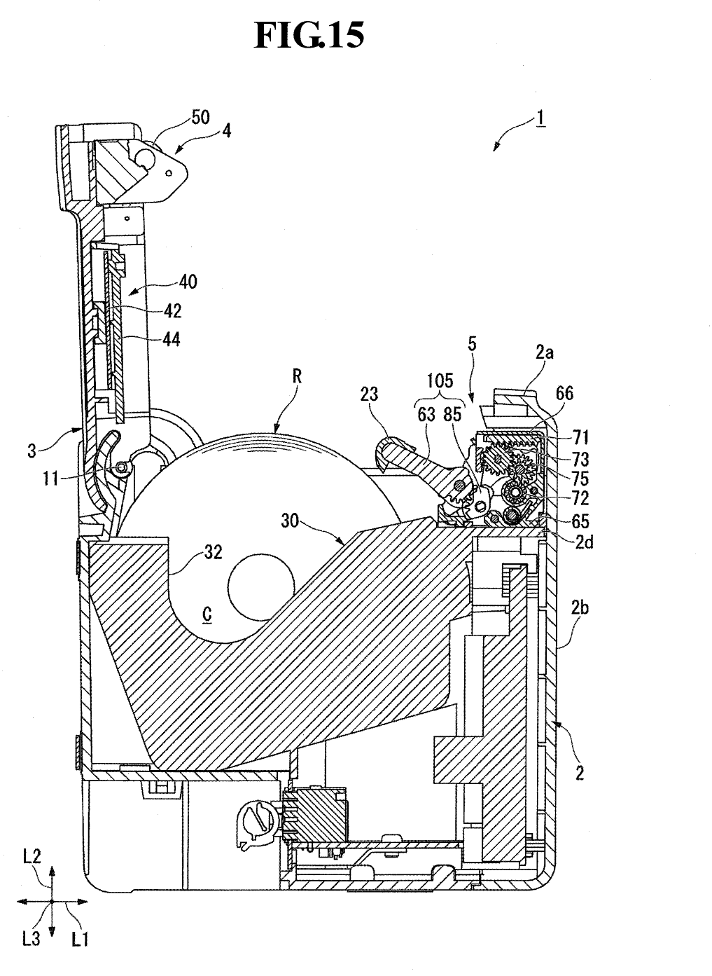

As illustrated in FIGS. 3, 14, and 15, the above-mentioned connector 23 is a member formed into a U-shape in cross section, which protrudes from the lever main body 21 toward the internal side of the casing 2, and is coupled to the lever portion 63 of the head unit 5. Specifically, the leading end portion of the lever portion 63 is inserted and fitted inside the connector 23. With this, the lever portion 63 is operated in association with the pivot operation of the release lever 20. Specifically, as illustrated in FIG. 14, by pivotably operating the release lever 20 from the lock position P1 to the release position P2, the lever portion 63 can undergo the push-down operation. With this, the lock shaft 103 can be disengaged from the lock groove 102 so as to release the combination between the head unit 5 and the platen unit 4.

Next, the action of the thermal printer 1 configured as described above is described. First, as illustrated in FIGS. 2 and 3, after the paper roll R is placed and set inside the paper roll receiving portion 10 of the casing 2, the printer cover 3 undergoes a closing operation to be completely closed. Then, the bearing 50a of the platen roller 50 is fitted into the fitting hole 101 on the head unit 5 side, and the lock shaft 103 is fitted to the lock groove 102 on the head unit 5 side to obtain a locked state. With this, the head unit 5 and the platen unit 4 are combined with each other to obtain the locked state, and the printer cover 3 is locked to the casing 2 by the above-mentioned lock.

Note that, through the lock of both the units 4 and 5, the thermal head 60 and the platen roller 50 are brought into press contact with each other at a predetermined pressure under a state in which the recording paper P is sandwiched therebetween. Further, after the recording paper P is caused to pass between the movable blade 61 and the fixed blade 51, as illustrated in FIG. 1, the recording paper P is pulled outside the casing 2 from the discharge port 12.

Next, various information is printed on the recording paper P. In this case, as illustrated in FIG. 12, the platen motor M2 is driven to rotate the platen drive gear 91. Then, this rotational force is transmitted to the driven gear 50b via the platen gear train 90 to rotate the platen roller 50. With this, the recording paper P sandwiched between the outer circumferential surface of the platen roller 50 and the thermal head 60 can be fed upward of the casing 2. Further, simultaneously therewith, a control signal corresponding to printing data is output to the thermal head 60 so that the heat generating elements 60a appropriately generate heat. With this, various characters, graphic, and the like can be clearly printed onto the fed recording paper P. After that, the printed recording paper P is caused to pass between the fixed blade 51 and the movable blade 61.

Next, when the recording paper P is cut, the cutter motor M1 is driven to rotate the drive gear 72. Then, as illustrated in FIG. 11, this rotational force is transmitted to the first gear 73 via the second gear 75, and simultaneously with the rotation of the first gear 73, the third gear 74 coupled to the first gear 73 via the shaft 76 is rotated. With this, the racks 71 respectively meshing with the first gear 73 and the third gear 74 can linearly move, and thus the movable blade 61 can move in a sliding manner toward the fixed blade 51. As a result, as illustrated in FIG. 10, the recording paper P can be sandwiched between the fixed blade 51 and the movable blade 61 to be cut, and the cut recording paper P can be used as, for example, a receipt or a ticket.

Next, a case where the printer cover 3 is opened is described. In this case, as illustrated in FIG. 5, for example, a fingertip is hooked to the operation protruding piece 22a in the release lever 20 to move the operation protruding piece 22a backward. With this, the release lever 20 can be moved from the lock position P1 to the release position P2. In association with the release lever 20, the lever portion 63 of the head unit 5 can undergo the push-down operation.

As a result, as illustrated in FIG. 13, the release plate 85 can be rotated so that the lock shaft 103 on the platen unit 4 side is disengaged from the lock groove 102 on the head unit 5 side. In this manner, the combination between the platen unit 4 and the head unit 5 can be released to obtain a separable state. With this, the opening operation of the printer cover 3 can be performed. After that, by opening the printer cover 3, the paper roll R can be taken out or replaced from the paper roll receiving portion 10.

In particular, according to the thermal printer 1 of this embodiment, the operation unit 40 including the operation buttons 41 and the control board 42 is provided on the printer cover 3 side, and hence it is unnecessary to secure a space required for mounting the operation unit 40 on the casing 2 side. Therefore, the casing 2 can be accordingly downsized, and the paper roll access space C as an open space can be secured around the paper roll receiving portion 10. In addition, the release lever 20 for releasing the lock of the printer cover 3 is provided on the casing 2 side. Therefore, as compared to the related art in which the release lever 20 is provided on the printer cover 3 side, there is a degree of freedom in its mounting position, and the release lever 20 can be arranged in consideration of the relationship with the paper roll receiving portion 10. Therefore, also in view of this point, the above-mentioned paper roll access space C can be secured. Therefore, the printer can be downsized, and further, the paper roll R can be easily taken out or replaced with use of the paper roll access space C.

Further, the printer cover 3 can be locked with use of the lock of the combination between the platen unit 4 and the head unit 5. Therefore, it is unnecessary to provide another lock mechanism for the printer cover 3, and the configuration of the release lever 20 provided on the casing 2 side can be simplified. Therefore, the paper roll access space C can be further easily secured around the received paper roll R. Further, the platen motor M2 and the cutter motor M1 are provided to the head unit 5, and hence it is unnecessary to provide another motor on the casing 2 side separately from those in the head unit 5. Therefore, accordingly, a further wide-range a paper roll access space C can be easily secured.

As a result, according to the thermal printer 1 of this embodiment, as illustrated in FIG. 3, large paper roll access spaces C that enable exposure of both the end surfaces of the paper roll R can be secured, and the paper roll R can be easily taken out or replaced without touching, for example, the outer circumferential surface of the paper roll R. In particular, when the diameter of the paper roll R is small, in a case of the paper roll R having a back surface printed with a monetary added value such as a discount coupon or a lottery ticket, the paper may be temporarily taken out from the printer for the purpose of paper storage. In such an application, the paper roll R is required to be replaceable regardless of the diameter of the paper roll R, and hence it can be said that this embodiment is particularly effective.

Note that, according to the thermal printer 1 of this embodiment, the following actions and effects can be further produced. That is, even when the recording paper P is jammed between the fixed blade 51 and the movable blade 61 during use, this jamming can be removed along with the opening operation of the printer cover 3. This point is described.

When the release lever 20 is moved from the lock position P1 to the release position P2 and the lever portion 63 of the head unit 5 undergoes the push-down operation as illustrated in FIG. 13, the sector gear 58 on the platen unit 4 side is rotated. When the sector gear 58 is rotated, the shaft 56 and the two pressing portions 57 are rotated along therewith, and thus the blade edge 51a side of the fixed blade 51 is pushed downward by the pressing portions 57. With this, the fixed blade 51 can be forcibly moved in a direction in which the fixed blade 51 is separated from the movable blade 61, and thus the contact pressure between the movable blade 61 and the fixed blade 51, which has caused the jamming, can be released.

On the other hand, simultaneously with the rotation of the sector gear 58 caused by the push-down operation of the lever portion 63, the release gear 85a is also rotated. Therefore, the release plate 85 is rotated toward the drive gear 72 side so that the pin 81 of the swing plate 80 is moved toward the drive gear 72 side with a force against the torsion spring 83. Then, the swing plate 80 is rotated to separate the second gear 75 from the drive gear 72. In other words, in association with the push-down motion of the lever portion 63, the release mechanism 64 moves the second gear 75 meshing with the drive gear 72 so as to be separated from the drive gear 72. With this, as illustrated in FIG. 13, the mechanical connection between the rack 71 and the drive gear 72 is disengaged to remove the movement restriction of the rack 71. Thus, a free state is obtained.

Therefore, the engagement with the cutter motor M1 is released, and hence the first gear 73 and the third gear 74 can be moved irrespective of the cutter motor M1. Therefore, the pinion 86 is rotated by the rotational biasing force of the coil spring 87, and thus the third gear 74 is reversely rotated. The third gear 74 is coupled to the first gear 73 via the shaft 76, and hence, as a result, the first gear 73 is also reversely rotated simultaneously. At this time, as described above, the contact pressure between the fixed blade 51 and the movable blade 61 has already been released by the interlocking mechanism 54 on the platen unit 4 side, and hence it is possible to move the racks 71 in the opposite direction by the reverse rotation of the first gear 73 and the third gear 74 so that the movable blade 61 returns to the original position.

As described above, through the push-down operation of the lever portion 63, the contact pressure between the fixed blade 51 and the movable blade 61 can be released, and the movable blade 61 can be returned to the original position. After that, through a further push-down operation of the lever portion 63, the printer cover 3 can be opened. Therefore, even when the recording paper P is jammed, the opening operation of the printer cover 3 can be performed in a series while removing the jamming.

Note that, the technical scope of the present invention is not limited to the above-mentioned embodiment, and various modifications can be made thereto without departing from the gist of the present invention.

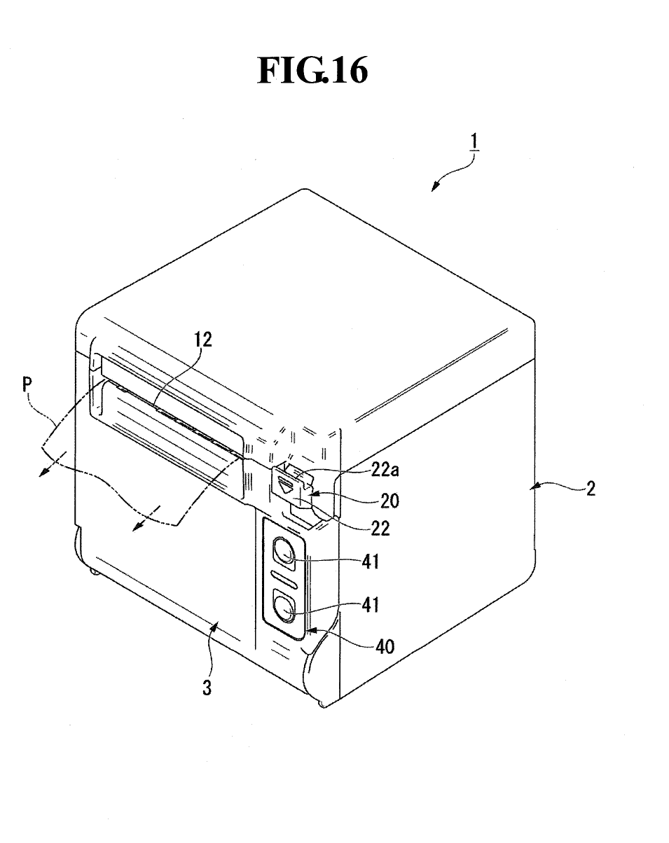

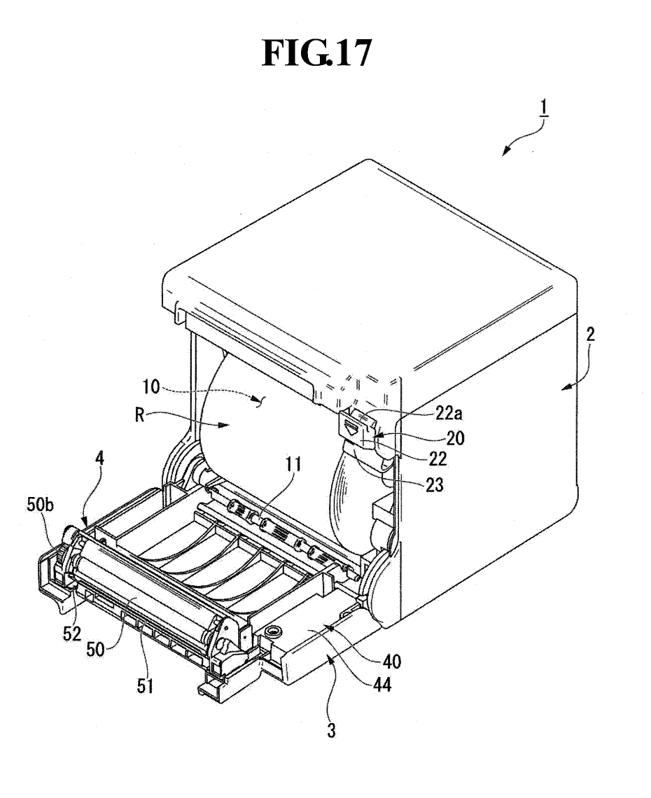

For example, in the above-mentioned embodiment, the thermal printer 1 has been described as an example of the printer, but the present invention is not limited to a thermal printer. Further, the case where the recording paper P is discharged upward is exemplified, but the installation attitude of the printer can be arbitrarily changed. For example, as illustrated in FIGS. 16 and 17, the printer may be used in a manner that the casing 2 is transversely placed so that the recording paper P is discharged forward. As described above, according to the thermal printer 1 of this embodiment, there is no particular limitation on the installation attitude, and the installation attitude may be appropriately selected in accordance with the discharge direction of the recording paper P.

Further, in the above-mentioned embodiment, the platen unit 4 is provided on the printer cover 3 side, and the head unit 5 is provided on the casing 2 side, but the present invention is not limited to this case. The head unit 5 may be provided on the printer cover 3 side, and the platen unit 4 may be provided on the casing 2 side.

Further, in the above-mentioned embodiment, the cutter mechanism 70 including the fixed blade 51 and the movable blade 61 is provided, but the cutter mechanism 70 is not a necessary configuration, and the function as the printer can be exhibited even without the cutter mechanism 70. Note that, the functionality can be enhanced and the value can be added as the printer, and hence the cutter mechanism 70 is preferred to be provided. In particular, even when the cutter mechanism 70 is provided, the fixed blade 51 and the movable blade 61 can be separably combined with each other along with the opening and closing operation of the printer cover 3, and hence the maintenance and the like of both the blades 51 and 61 can be facilitated. Note that, in the above-mentioned embodiment, the head unit 5 includes the movable blade 61, and the platen unit 4 includes the fixed blade 51, but the present invention is not limited to this case. The head unit 5 may include the fixed blade 51, and the platen unit 4 may include the movable blade 61.

Further, in the above-mentioned embodiment, the release lever 20 is pivoted between the lock position P1 and the release position P2, but the present invention is not limited to this pivot operation system. For example, the release lever 20 may be operated through a push-down operation or a sliding operation. In any cases, it is sufficient that the release lever 20 be caused to reciprocate between the lock position P1 and the release position P2 to release the lock of the printer cover 3.

Further, in the operation unit 40 of the above-mentioned embodiment, the switch 43 mounted on the control board 42 is directly depressed by the operation button 41, but the switch 43 may be depressed via a relay component or the like.

Further, the thermal printer 1 of the above-mentioned embodiment may be further additionally provided with, for example, the following functions:
(1) a mechanism for detecting the remaining amount of the paper roll R and confirming the detected remaining amount;
(2) a mechanism for detecting an identification such as a mark that is displayed in advance by printing or the like on the recording paper P;
(3) a mechanism for reducing the transportation load of the recording paper P;
(4) a mechanism for removing the looseness of the recording paper P, such as the tension roller 35;
(5) a damper mechanism provided for an instantaneous tension of the recording paper P;
(6) a mechanism for removing the winding habit of the recording paper P; and
(7) a damper mechanism for restricting a rapid opening and closing motion of the printer cover 3.

What is claimed is:

1. A printer including:
a case including a paper roll receiving portion for receiving a paper roll;
a printer cover that is openably and closably coupled to the case and locked at the time of a closing operation; a platen unit including a platen roller for feeding recording paper pulled out from the paper roll; and
a head unit that includes a printing head and is separably engaged relatively with respect to the platen unit, in which: one of the platen unit and the head unit is mounted to the printer cover,
wherein the printer cover includes an operation unit including an operation button and a control board;
another of the platen unit and the head unit is mounted to the case; and
the case includes a release operation member that is capable of reciprocating between a lock position and a release position and releases a lock of the printer cover when being moved to the release position.

2. A printer according to claim 1, wherein
the one of the platen unit and the head unit includes a lock member to be removably engaged with a portion to be engaged, which is formed on the another of the platen unit and the head unit, at the time of the closing operation of the printer cover, and
the another of the platen unit and the head unit includes a unit release mechanism that is configured to actuate in association with the release operation member and cause, when the release operation member is moved to the release position, the lock member to be disengaged from the portion to be engaged so as to release combination between the one of the platen unit and the head unit and the another of the platen unit and the head unit.

3. A printer according to claim 1, wherein
the platen unit is provided to the printer cover, the head unit is provided to the case and includes a platen motor for rotating the platen roller, and
the platen roller is rotated by receiving a rotational force from the platen motor when the head unit and the platen unit are combined with each other.

4. A printer according to claim 1, wherein
the printer further includes a cutter mechanism for cutting the recording paper,
the cutter mechanism including a fixed blade and a movable blade, and one of the fixed blade and the movable blade is provided to the head unit, while another of the fixed blade and the movable blade is provided to the platen unit.

5. A printer according to claim 2, wherein
the platen unit is provided to the printer cover, the head unit is provided to the case and includes a platen motor for rotating the platen roller, and
the platen roller is rotated by receiving a rotational force from the platen motor when the head unit and the platen unit are combined with each other.

6. A printer according to claim 5, wherein
the printer further includes a cutter mechanism for cutting the recording paper,
the cutter mechanism including a fixed blade and a movable blade, and one of the fixed blade and the movable blade is provided to the head unit, while another of the fixed blade and the movable blade is provided to the platen unit.

7. A printer according to claim 3, wherein
the printer further includes a cutter mechanism for cutting the recording paper,
the cutter mechanism including a fixed blade and a movable blade, and one of the fixed blade and the movable blade is provided to the head unit, while another of the fixed blade and the movable blade is provided to the platen unit.
